(19) United States
(12) Patent Application Publication
(10) Pub. No.: US 2017/0126611 A1
(43) Pub. Date: May 4, 2017

(54) Funtimes social network to promote happiness

(71) Applicant: Raghunathan Rajan, New Delhi (IN)

(72) Inventor: Raghunathan Rajan, New Delhi (IN)

(21) Appl. No.: 14/925,990

(22) Filed: Oct. 29, 2015

(51) Int. Cl. H04L 12/58; H04L 29/08

(52) U.S. Cl. CPC H04L 51/32; H04L 67/306; H04L 67/22

(57) ABSTRACT

The present invention is a funtimes social network which can be used to share anything fun you come across in your daily life or any fun event happening in your life to promote happiness. The present social network website doesn't allow any other posts other than these to make people avoid sharing stuff which might be boring to others like selfies, food, sentimental stuff, plain pictures, boring status updates etc. If people share stuff which are not fun (whether own life or something they came across), then those posts will be removed by the site administrator.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Field of the Invention

The present invention relates generally to Social Networks, more particularly the present invention relates to a social network for sharing only fun things in life and nothing serious.

Description of the Related Art

In recent years, there is a lot of social networking websites, some of them specialize in specific topics like politics but there is not any fun social networking websites, In light of all these bad news we reading every day, it has become an urgent need to develop a social network website that specializes in fun things in life and this is what provided by the present invention, also there are some unique features in the present invention make it unique compared to the other social networks websites. In the present invention the process of communicating with others via social networks become more fun and less boring posts, more interactive though innovative features to easily make friends and more easier to report any violation.

### BRIEF SUMMARY OF THE INVENTION

A social fun network has the following features:

‘Emoticon LIKE’ Function that is a Like function which enables a person to like a post on three varying levels of laughter emotion (funny, sweet, ribtickler) and also see results of others in these three levels gender wise after liking.

The Hi Function that is an interactive feature to say Hi to people who have like your posts but are not friends. This feature can then be used to develop friendship through a process.

Pull The plug function that is a violation reporting tool which gives the ability to the user to report and take action on others users or posts.

Silent Mode that can be used so a user can put another user in silent mode to make the other user a silent spectator to his/her activity on the social network but preventing the other user from interacting via comments or likes except the personal mail system.

Personal Pics & Videos Folder where is a user can store personal pictures or videos and control sharing and unsharing of his/her pictures or videos.

### DESCRIPTION OF THE DRAWINGS

For a more complete understanding of the present invention, reference is now made to the following descriptions:

FIG. 1 The symbols will be used in the drawings.

FIG. 2 The two types of profiles based on Gender a user can create when he want to use the website and the three varying intensity of emotion or laughter icons for female and three varying intensity of emotion or laughter icons for male.

FIG. 3 The three varying intensity of emotion or laughter icons for female and three varying intensity of emotion or laughter icons for male, Sweet, Funny and Ribtickler.

FIG. 4 The emoticon shows how everyone has reacted to the post in the three levels of emotion along with the gender.

FIG. 5 Shows If there are people who have liked the post but are not your friends and show how hi alert notification work.

FIG. 6 Shows If there are people who have liked the post but are not your friends and show how hi alert notification work.

FIG. 7 Shows when a user says hi to you, you can either say Hi back, Hi Do I know you or Add as friend directly.

FIG. 8 Shows when you say hi back to the user, the Hi sender receives a Hi revert in his profile.

FIG. 9 Shows that the other person has to confirm so that friendship is created.

FIG. 10 Shows if the user presses Hi, Do I know you?, in response to the Hi request, then Hi sender has to answer the question ‘Hi , Do I know you?.

FIG. 11 Shows the Do I know you revert.

FIG. 12 Shows the checkbox of the silent mode.

FIG. 13 Show how the pull the plug icon appears when the checkbox of the silent mode selected.

FIG. 14 Shows the message appear when we mouseover the pull the plug icon.

FIG. 15 Shows when we click the pull the plug icon there is a popup appears, in this popup with menu options we can see two group of icons.

FIG. 16 An example of the silent mode.

FIG. 17 Shows there are personal pictures folder and personal videos folder which are only visible to the user and not to the public from a person profile.

FIG. 18 Shows when personal pics folder is clicked, It opens up a page where it shows the personal funpic albums which belongs to the user.

FIG. 19 Shows the personal pictures sharing dashboard and also the personal pictures stored in this album.

FIG. 20 Shows that images which are shared are indicated ‘by shared to selected, it is shows the list of friends to whom this image has been shared, also it is shows unshare methods.

FIG. 21 Shows the default unshare method.

FIG. 22 Shows the personal videos section and the dashboard that is similar to the personal pictures which can then be shared in a customized manner.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

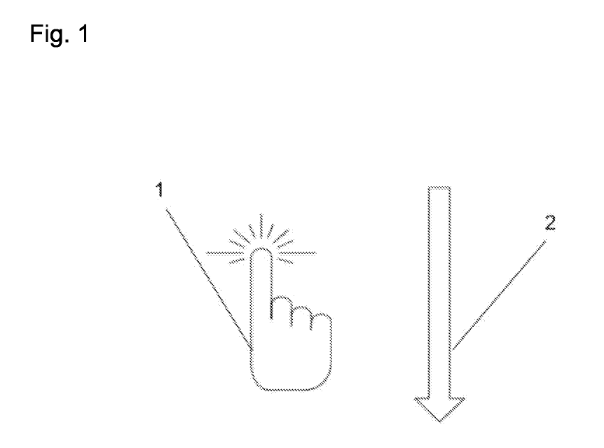

Referring to FIG. 1 the hand 1 symbolizes the cursor clicking on the option/link in the website and the arrow 2 indicates the next screen flow after a link is clicked.

In the following we will explain in details the main unique functions in the present invention.

1—The emotion like function with hi feature for gaining new friends.

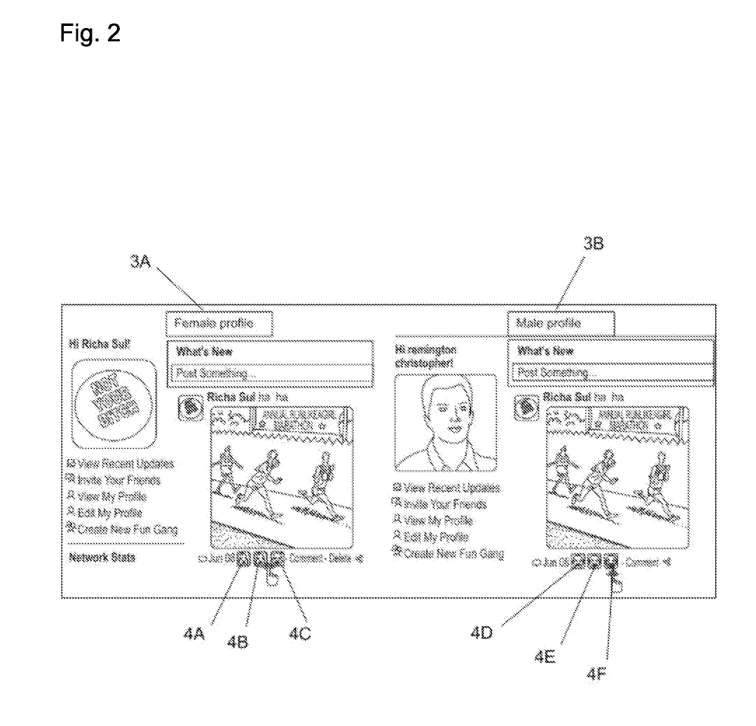

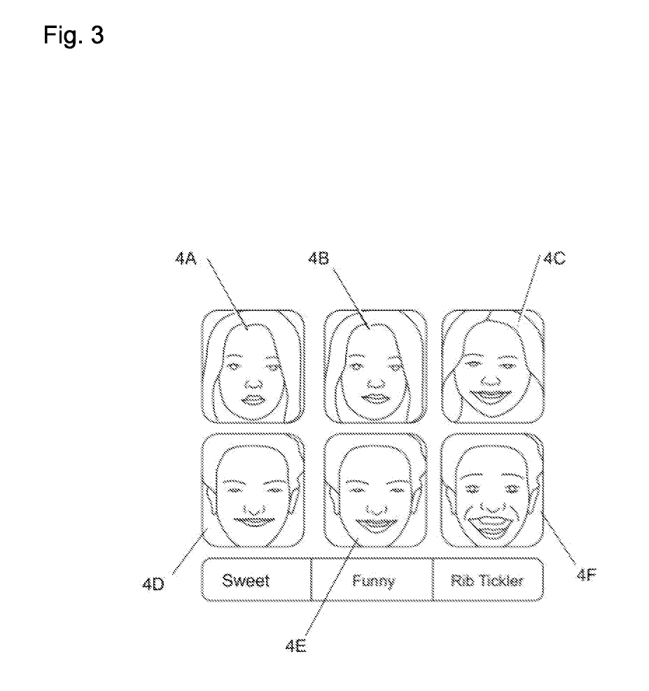

Referring to FIG. 2 there are two types of profiles a user can create when he want to use the website, these types are the female profile 3A and the male profile 3B, based on that and referring to FIG. 2 and FIG. 3 each of the post in the wall user will have three varying intensity of emotion or laughter icons for female and three varying intensity of emotion or laughter icons for male 4, Sweet 4A and 4D, Funny 4B and 4E, and Ribtickler 4C and 4F.

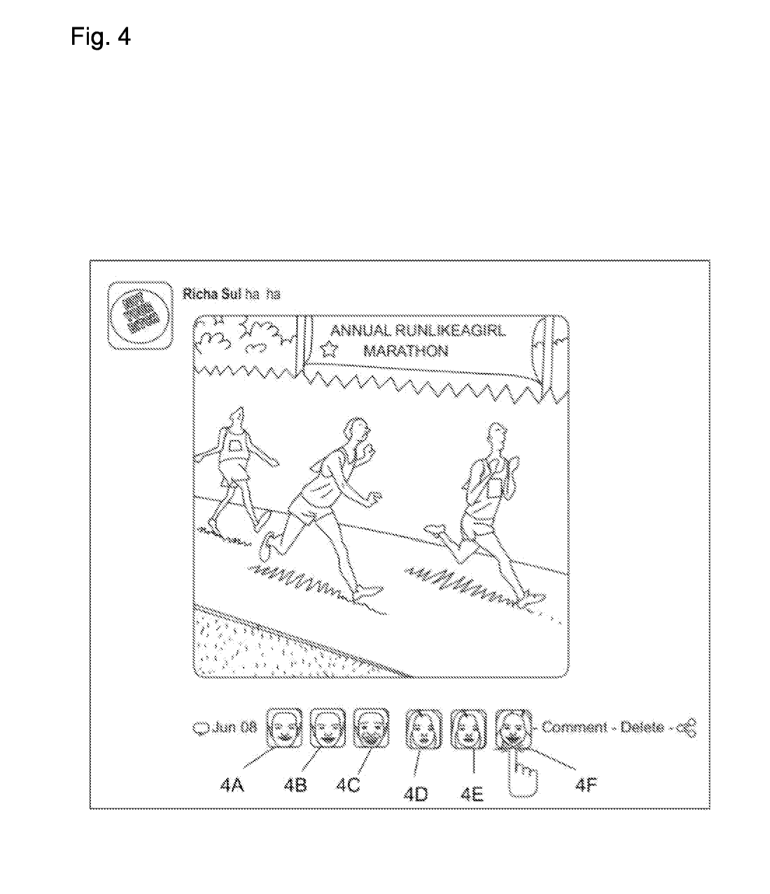

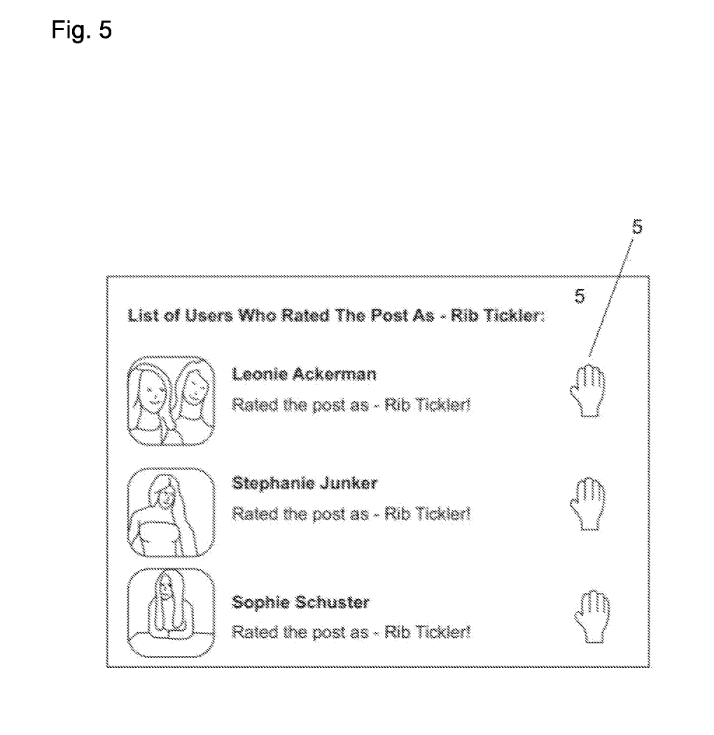

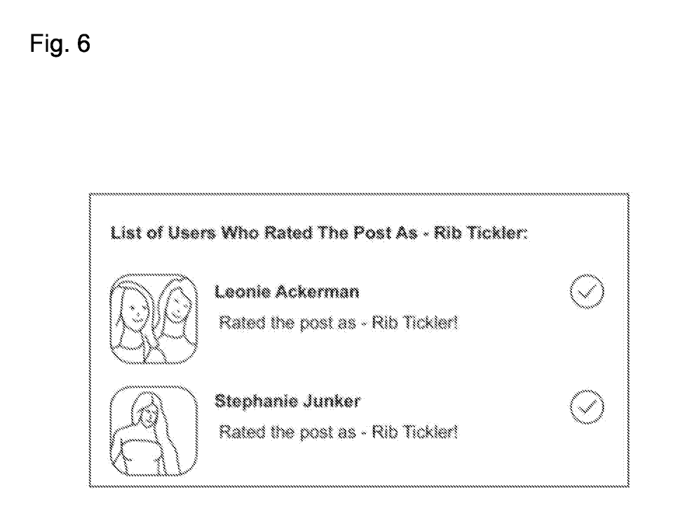

When the user presses one of the emoticons 4 depending on how he feels about the funniness or enjoyment level of the video, the process given in the next slide happens. Referring to FIG. 4 the emoticon 4 shows how everyone has reacted to the post in the three levels of emotion (Sweet 4A and 4D, Funny 4B and 4E, Ribtickler 4C and 4F) along with the gender. To know the count of likes in each of the emoticons 4, one can just mouse over each of the emoticons 4 or press them. When they press over any of the emoticon buttons, it opens up a list of people who liked the post in that level of emotion (Sweet 4A and 4D, Funny 4B and 4E, or Ribtickler 4C and 4F) as shown in FIG. 5. Referring to FIG. 5 and FIG. 6 If there are people who have liked the post but are not your friends, then you will see a hi icon (the hand symbol) 5 next to the image alongside the name. You can click the hi Icon 5 to say hi to them only once then the receiver would receive a hi alert notification.

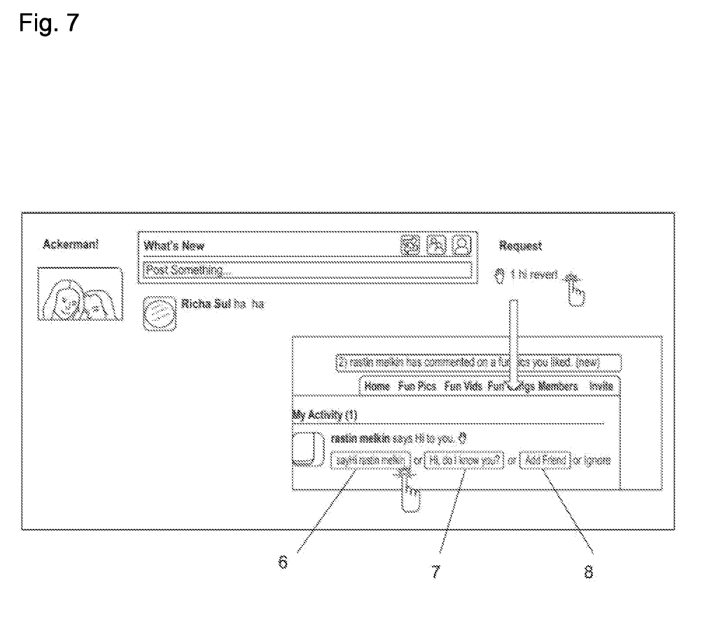

Referring to FIG. 7 when a user says hi to you, you can either say Hi back 6, Hi Do I know you 7 or Add as friend 8 directly.

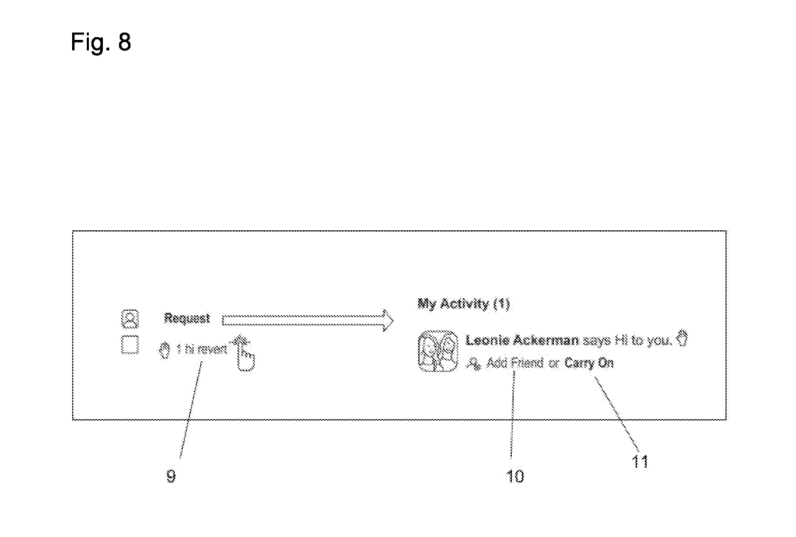

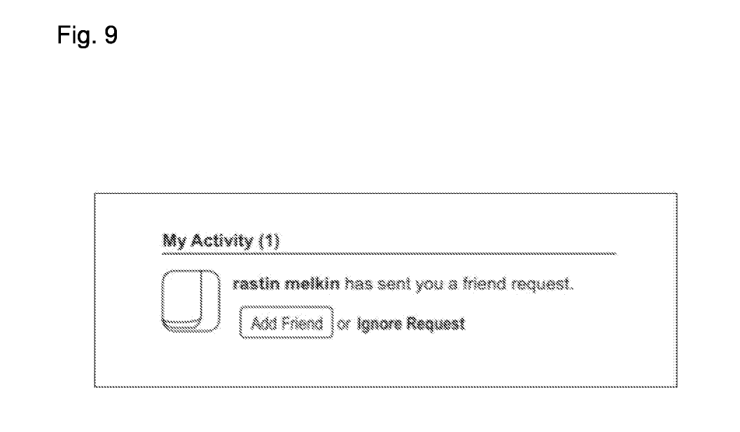

Referring to FIG. 8 and FIG. 9 when you say hi back to the user, the Hi sender receives a Hi revert 9 in his profile. He can then add as the person who reverted hi as a friend 10 or carry on 11. If he presses add friend 10, then the other person has to confirm so that friendship is created. This multi stage confirmation using hi feature gives time to people from both ends to check the other person's profiles instead of blatantly rejecting add friend request. Also the Hi feature is more subtle so it encourages forming of friendships with new people and making people feel less disturbed or awkward while receiving new friend requests.

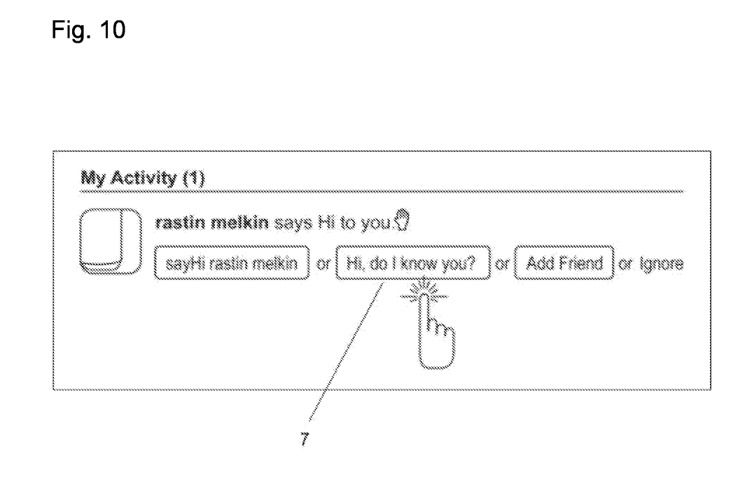

Referring to FIG. 10 if the user presses ‘Hi , Do I know you? 7 in response to the Hi request, then Hi sender has to answer the question ‘Hi , Do I know you? 7.

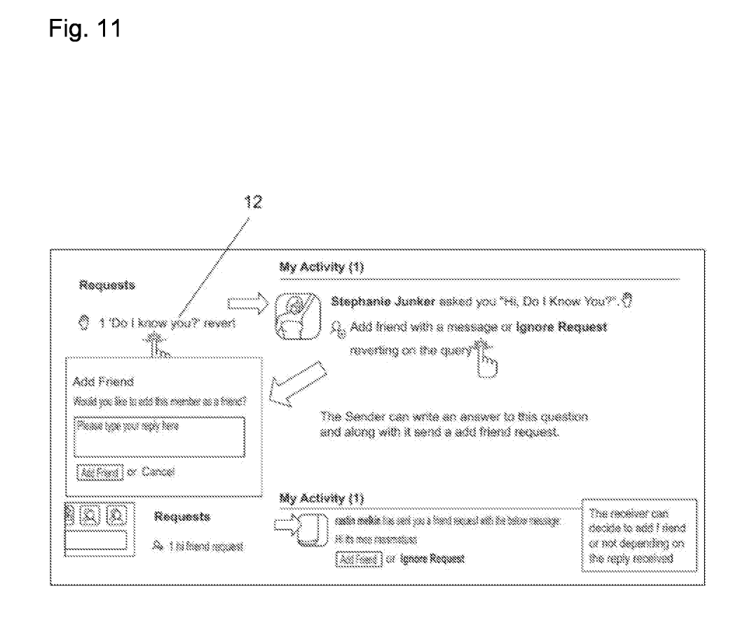

Referring to FIG. 11 the Hi Sender receives a ‘Do I know you revert 12’ the ‘Do I know you’ revert system allows users to have a single line text interaction with the friendship requester to evaluate for adding as a friend or not instead of blatantly rejecting any friend request just to avoid looking needy or due to caution or concern.

2—Silent mode in user privacy control in social network.

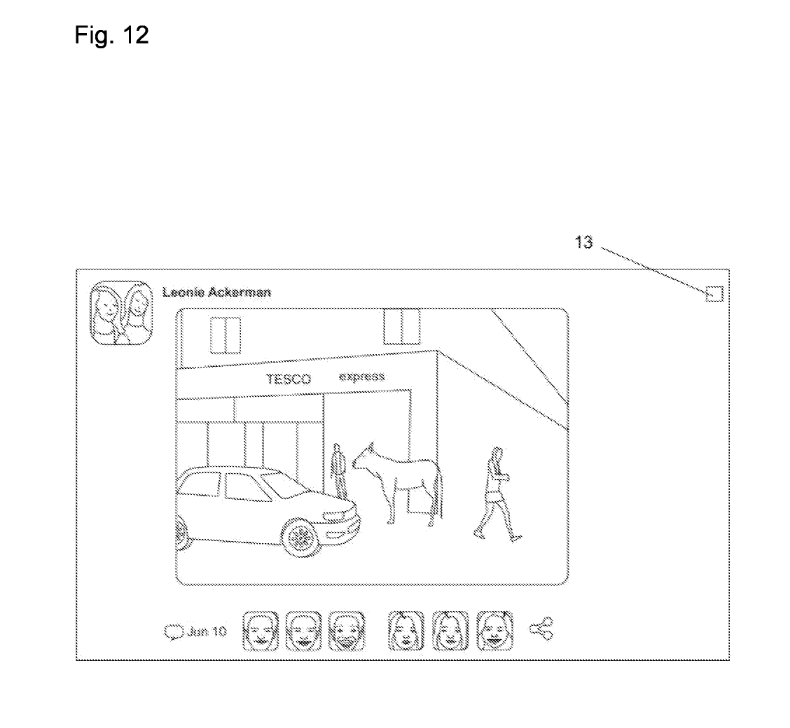

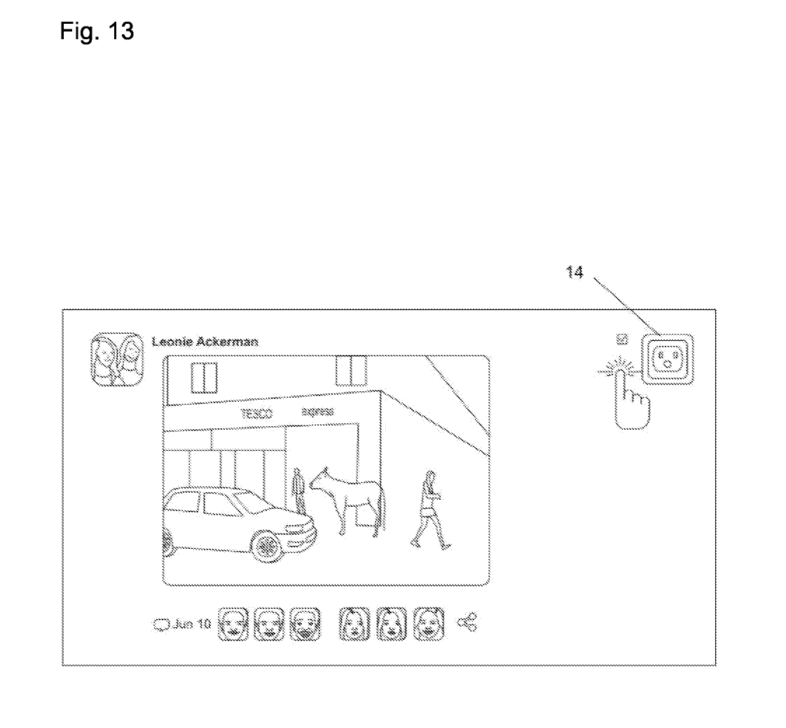

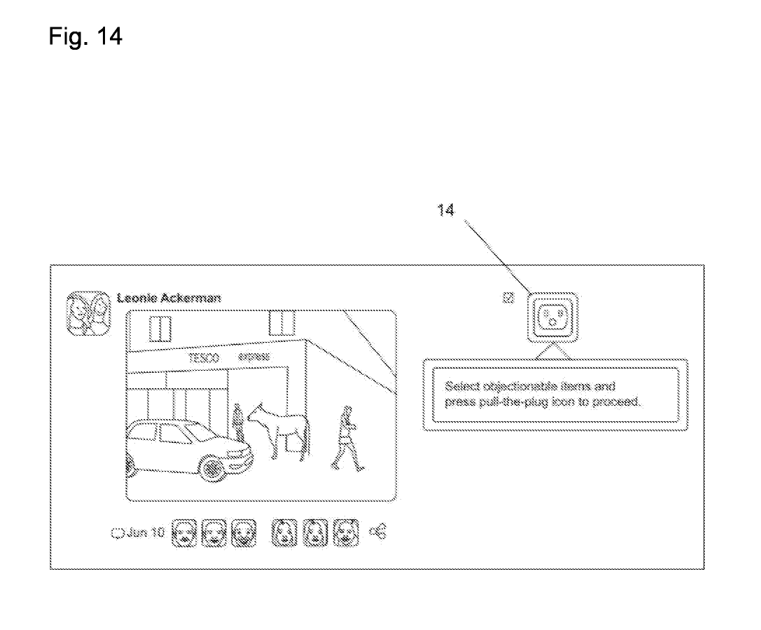

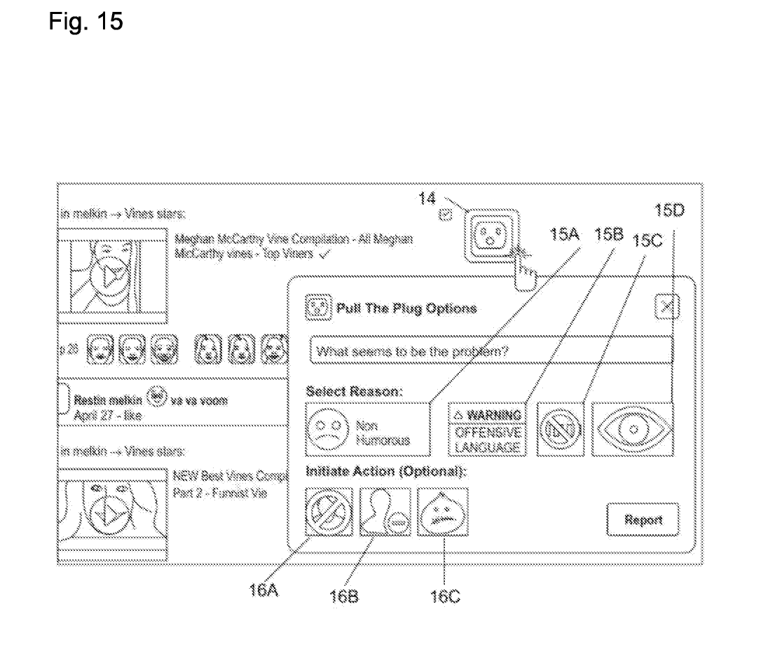

We have pull the plug function for privacy abuse reporting and control in this social network Referring to FIG. 12 there is a check box 13 which appears on mouse over near the top right corner of every post, Post archives and member directory throughout the network. Referring to FIG. 13 when this check box 13 is selected, then the pull the plug icon 14 appears. Referring to FIG. 14 on mouseover, the pull the plug icon 14 give the following messages—You can select one post or many post you find offensive in the same window. Referring to FIG. 15 after selecting all the objectionable items if any and pressing the icons, we get the mentioned popup with menu options. In this figure we can see two group of icons, the first group 15 consists of four icons that can be used for reporting by clicking any of them. The icon of non humorous 15A for non humorous by any standards, the icon of warning offensive language 15B for the words that are derogatory, eg: racist, religions, discriminatory, propaganda etc, the icon of cyber bully 15C to refer to this person has been bullying me or everyone else in the feed, and the icon of stalker 15D to refer to this ‘creeps been on to me like a leech’, I am scared of this person and fear that I am being stalked online.

The second group 16 consists of three icons for three types of actions can be taken by user if needed. The icon of block User 16A for blocks and removes access/visibility from both sides. The icon of unfriend 16B for the person's friendship with you is removed, He can view your profile and public posts only but can no longer interact like & comment with user except internal mail. And the icon of silent mode 16C is the exclusive mode, The user can put a person in silent mode. The person will be able to see all the activities of user as a normal friend but would not be able to like or comment on the same. He would be a passive viewer.

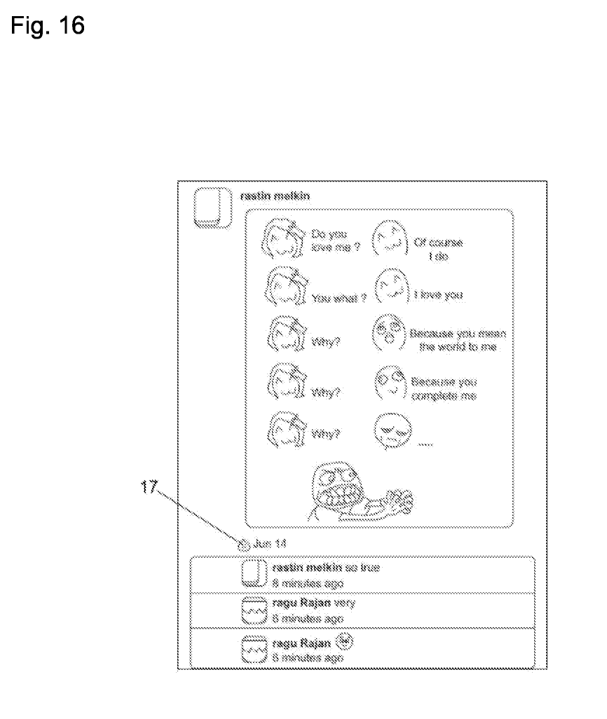

Referring to FIG. 16 this is a silent mode example, there is post visible but no comment or like box because the poster has put you in silent mode. You can only view activity but can interact at all except via internal Funmail. We can activate the silent mode by clicking the silent mode icon 16C and pressing report button.

3—Personal pictures and personal videos sharing function to specific user groups.

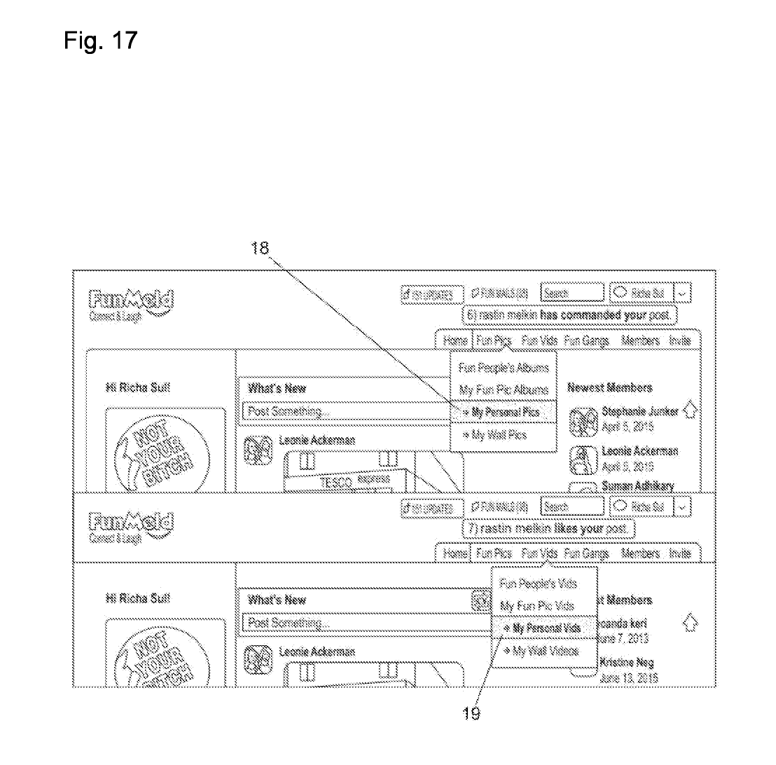

Referring to FIG. 17 there are both personal pictures folder 18 and personal videos folder 19 which are only visible to the user and not to the public from a person profile.

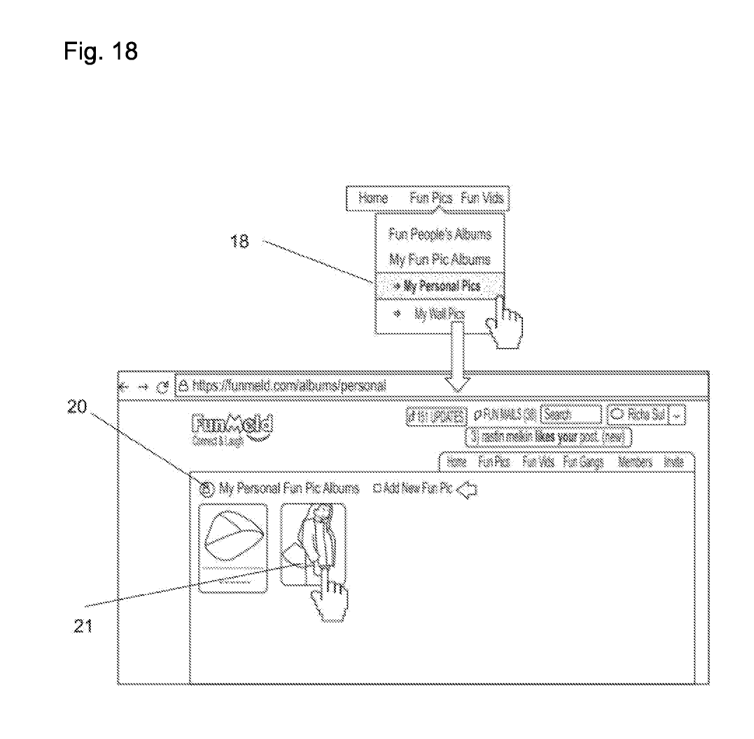

Referring to FIG. 18 when personal pics folder 18 is clicked, It opens up a page where it shows the personal funpic albums 20 which belonging to the user.

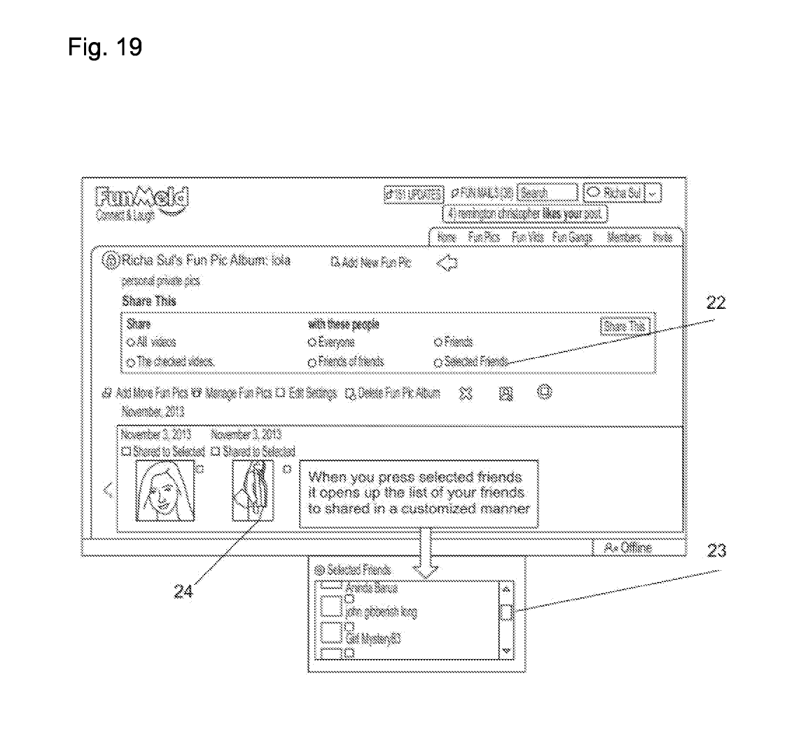

When one of the album thumbnails 21 is clicked as shown in FIG. 18, referring to FIG. 19 it opens up the personal pictures sharing dashboard and also the personal pictures stored in this album. When you press selected friends 22 it opens up the list of your friends 23 to share in a customized manner. Here, you can check the images 24 and share them to everyone, friends or selected people.

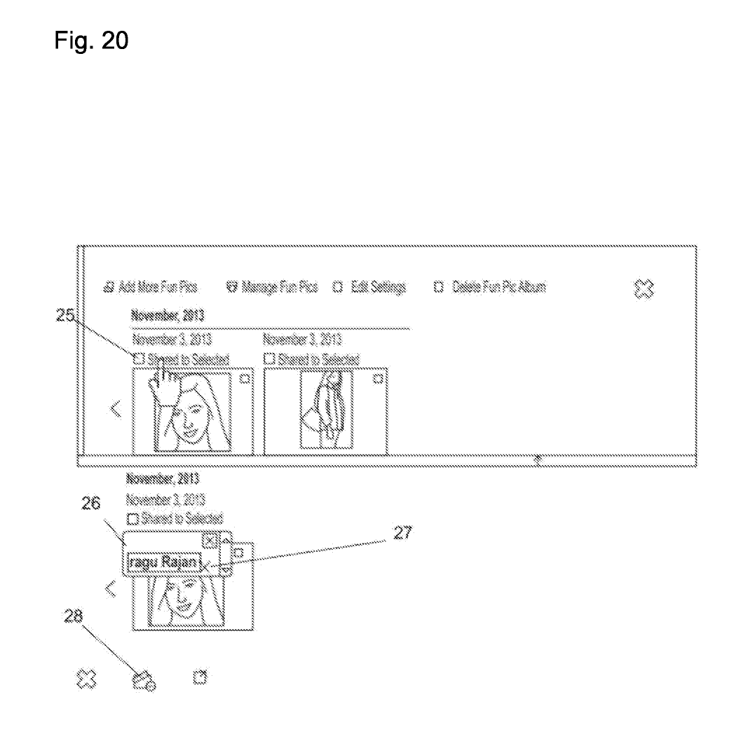

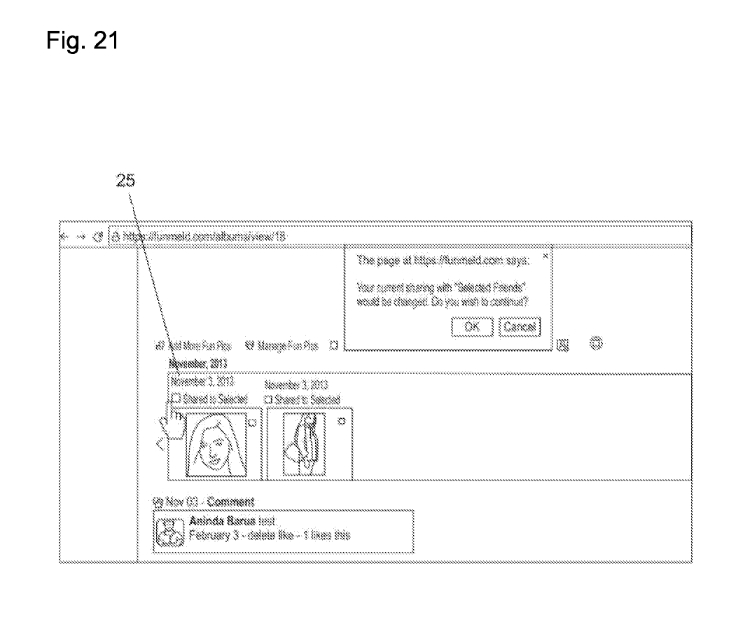

Referring to FIG. 20 images which are shared are indicated ‘by shared to selected ‘shared to Everyone’, ‘shared to Friends or FOF’. Depending on to whom it is shared. When shared to selected 25 is clicked, It opens up the list of friends 26 to whom this image has been shared. 1st unshare method: The selection can be unshared by clicking this ‘x’ 27 after which the image is unshared for that specific person or category. 2nd unshare method: Images can also be unshared as a whole by selecting the checkbox and pressing this unshare icon 28 in the dashboard, in this case everyone to whom it is shared to get unshared. As shown in FIG. 21 the 3rd unshare method is default: When you try to share an already shared image by selecting the checkbox of shared to selected 25, then the image when shared to someone else newly again becomes automatically unshared from the previous shared users. Also all shared images get unshared after 30 day automatically.

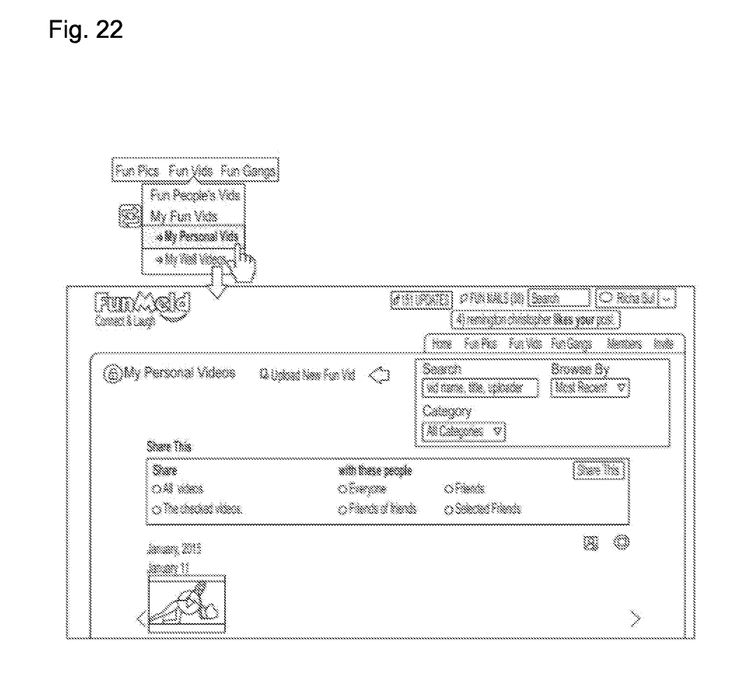

Referring to FIG. 22 it is the personal videos section where when my personal vids clicked 19 leads to a similar dashboard to that of personal pictures which can then be shared and Unshared in a customized manner.

1. A funtimes social network which can be used to share anything fun to promote happiness comprising:
emotion like function that will enables a person to like a post on three varying levels of laughter emotion (funny, sweet, ribtickler) and also see results of others in these three levels gender wise after liking;
the hi function that is an interactive feature to say hi to people who have like your posts but are not friends, this feature can then be used to develop friendship through a process;
pull the plug function that is a violation reporting tool which gives the ability to the user to report and take action on others users or posts;
silent mode that can make a website user to put another user in silent mode to make the other user a silent spectator to his/her activity on the social network but preventing the other user from interacting via comments or likes except the personal mail system; and
personal pics and videos folder in which user can store personal pictures or videos and control sharing and unsharing of his/her pictures or videos.
